(19) United States
(12) Patent Application Publication
(10) Pub. No.: US 2024/0396129 A1
(43) Pub. Date: Nov. 28, 2024

(54) SEAL, LID ASSEMBLY, ENERGY STORAGE CELL AND ASSEMBLY OF ENERGY STORAGE CELLS

(71) Applicant: VARTA Microbattery GmbH, Ellwangen Jagst (DE)

(72) Inventors: Waldemar FRANK, Ellwangen (DE); Michael GEIGER, Ellwangen (DE); Dominik KIENINGER, Rainau (DE)

(21) Appl. No.: 18/672,042

(22) Filed: May 23, 2024

(30) Foreign Application Priority Data
May 24, 2023 (DE) 102023113673.9
Jun. 27, 2023 (EP) 23181702.4

(51) Int. Cl. H01M 50/152; H01M 10/04; H01M 50/107; H01M 50/159; H01M 50/186; H01M 50/193

(52) U.S. Cl. CPC H01M 50/152; H01M 10/0431; H01M 50/107; H01M 50/159; H01M 50/186; H01M 50/193

(57) ABSTRACT

An annular seal for a lid assembly of an energy storage cell includes an outer annular segment with two ends. The outer annular segment continues, at a first end of the two ends, into an inward-facing collar that narrows the outer annular segment at the first end. An inner edge of the inward-facing collar continues into an inner annular segment. The outer annular segment also has an inwardly pointing circumferential nose provided with an undercut. A lid assembly including such an annular seal, an energy storage cell including such a lid assembly, and an assembly of such energy storage cells are also provided.

### CROSS REFERENCE TO RELATED APPLICATIONS

This application claims benefit to German Patent Application No. DE 10 2023 113 673.9, filed on May 24, 2023, and to European Patent Application No. EP 23181702.4, filed on Jun. 27, 2023, both of which are hereby incorporated by reference herein.

### FIELD

The present disclosure relates to a seal, a lid assembly provided therewith, an energy storage cell, and an assembly of energy storage cells.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, between which a separator is arranged. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte. The separator thus prevents direct contact between the electrodes. At the same time, however, it enables electrical charge equalization between the electrodes.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example.

Furthermore, the electrodes can comprise an electrode binder (e.g. polyvinylidene fluoride (PVDF) or another polymer, such as carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells usually comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion cell. The electrodes and separators are often, but by no means necessarily, joined together under pressure, possibly also by lamination or bonding. The basic functionality of the cell can then be established by impregnating the assembly with the electrolyte.

In many embodiments, the electrode-separator assembly is formed in the form of a winding or is processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in electric tools, lithium-ion cells with the highest possible energy density are required that are also capable of withstanding high currents during charging and discharging.

Cells for the applications mentioned are often designed as cylindrical round cells, for example with a form factor of 21×70 (diameter*height in mm). Cells of this type always comprise an assembly in the form of a winding. Modern lithium-ion cells of this form factor can achieve an energy density of up to 270 Wh/kg.

WO 2017/215900 A1 describes cylindrical round cells in which the electrode-separator assembly and its electrodes are ribbon-shaped and in the form of a winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact sheet metal member which sits on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

Cylindrical round cells such as those in WO 2017/215900 A1 are often used as part of a cell array in which several cells are connected in series and/or in parallel. It is often desirable to only have to contact the cells at one of their end faces in order to tap an electrical voltage. Accordingly, it is advantageous to provide both a connection pole connected to the positive electrode of the cell and a connection pole connected to the negative electrode of the cell on one of the end faces.

The housing of cylindrical round cells generally comprises a housing cup, which contains the wound electrode-separator assembly, and a lid assembly, which closes the opening of the housing cup. A seal is arranged between the lid assembly and the housing cup, which on the one hand serves to seal the cell housing, but on the other hand also has the function of electrically insulating the lid assembly and the housing cup from each other. The seal is usually mounted on the edge of the lid assembly. To close the round cells, the opening edge of the housing cup is generally bent radially inwards over the edge of the lid assembly enclosed by the seal (crimping process), so that the lid assembly including the seal is positively fixed in the opening of the housing cup.

An example of such a round cell is shown in FIG. 3 of EP 3188280 A1. It is relatively easy to weld the lid assembly (reference number 270) to a suitable conductor rail in order to integrate the cell shown into a cell assembly; the protruding pole cap (reference number 217) offers the best conditions for this. However, the electrical connection of the housing cup is more difficult. If one intends to contact the housing cup on the same end face on which the lid assembly is located, the conductor rail can only be welded to the radially inwardly bent opening edge (reference number 213) of the housing cup. The problem with this is that such a welding operation can easily damage the seal, which is in direct contact with the bent opening edge, as it is sensitive to thermal stresses that typically occur during welding. Round cells with a classic cell housing such as that described in EP 3188280 A1 are therefore usually not accessible for welding a current conductor to the opening edge.

From the PCT application PCT/EP2022/083072 of the applicant (published as WO 2023/094498 A1), an energy storage cell is known which has a housing in which a radially inwardly bent opening edge of a housing cup has an increased wall thickness. This measure ensures that conductor rails can be welded onto the radially inwardly bent opening edge of the housing cup without subsequent problems with the seal. The increased thickness of the opening edge ensures that the heat generated during welding can be better distributed, so that local overheating and melting of the seal can be avoided.

### SUMMARY

In an embodiment, the present disclosure provides an annular seal for a lid assembly of an energy storage cell. The annular seal includes an outer annular segment with two ends. The outer annular segment continues, at a first end of the two ends, into an inward-facing collar that narrows the outer annular segment at the first end. An inner edge of the inward-facing collar continues into an inner annular segment. The outer annular segment also has an inwardly pointing circumferential nose provided with an undercut. In further embodiments, the present disclosure provides a lid assembly including such an annular seal, an energy storage cell including such a lid assembly, and an assembly of such energy storage cells.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a general view (cross-sectional view) of an energy storage cell;

FIG. 2 shows an electrode-separator assembly, which may be part of an energy storage cell, and its components;

FIG. 3 shows an energy storage cell with two electrical conductors that are connected to the housing by a welding connection;

FIG. 4 an enlarged view of the weld seams according to FIG. 3;

FIG. 5 is a top view of a lid of a cell as shown in FIG. 1;

FIG. 6 shows a cross-section through a lid assembly comprising a seal; and

FIG. 7 is a photograph showing a section through a housing closed by means of a lid assembly as shown in FIG. 6.

### DETAILED DESCRIPTION

The present disclosure provides energy storage cells that are characterized by a high energy density and that can be efficiently integrated into a cell assembly. Furthermore, the energy storage cells should also be characterized by improved safety. In particular, the present disclosure provides for further improving the cells described in the aforementioned PCT/EP2022/083072.

According to an aspect, the present disclosure provides a seal having the following features a. to d:
a. It comprises an outer annular segment.
b. The outer annular segment continues at one of its two ends into an inward-facing collar that narrows the outer annular segment at this end.
c. The collar has an inner edge that continues into an inner annular segment.
d. The outer annular segment has an inward-facing, circumferential nose provided with an undercut.

Such a seal is used to close housings of the type described above, for example, housings as described in EP 3188280 A1. During assembly, often a lid assembly is used which, in addition to the seal, comprises other individual parts that are held together by the seal. The seal can serve as a retaining element to fix parts of the lid assembly in a corresponding holder (this is explained in more detail below). When the seal is compressed, however, the nose results in asymmetrical pressure distribution, which makes it difficult to form a flat cell shoulder that is suitable for welding on conductors.

Surprisingly, it was found that this problem can be solved by simply providing the nose with an undercut. The undercut creates space into which the region of the seal with the nose can expand during compression, eliminating the “nose interference factor” when closing the cell. This makes it possible to form a flat annulus-shaped surface at the shoulder of the cell during cell closure, which is available for electrical contacting of the cell.

The seal is preferably characterized by at least one of the following additional features a. to f:
a. The outer annular segment is hollow cylindrical.
b. The inner annular segment is hollow cylindrical or conically tapered.
c. The undercut is designed as an annular, groove-like recess.
d. The nose is formed as an annular elevation on the inside of the outer annular segment.
e. The nose provided with the undercut divides the outer annular segment into a central part segment and a terminal part segment.
f. The collar has an annular elevation on its inner side.

Preferably, the wall thickness of the outer annular segment is reduced in the region of the groove-like recess. It is also preferred that the wall thickness of the outer annular segment is increased in the region of the nose.

According to an aspect, the present disclosure provides a lid assembly having the features a. to i. immediately below:
a. It comprises a pole cap with a circular edge.
b. It comprises a first metal disk with a circular edge.
c. It comprises a second metal disk with a circular edge.
d. It comprises an annular seal.
e. It comprises an annular insulator.
f. The first metal disk is located between the pole cap and the second metal disk.
g. The annular insulator electrically insulates the first metal disk and the second metal disk from each other.
h. The first metal disk is in direct contact with the pole cap.
i. The annular seal is mounted on the circular edge of the pole cap and/or on the circular edge of the first metal disk.

The lid assembly is characterized by the following features j. to l:
j. The seal is designed like the seal described above.
k. The circular edge of the pole cap and/or the circular edge of the first metal disk rests on the collar.
l. The circular edge of the pole cap and/or the circular edge of the first metal disk is held in place by the nose.

Preferably, the collar, the central part segment and the nose form a receptacle for the circular edge of the pole cap and/or the circular edge of the first metal disk.

The lid assembly is preferably characterized by at least one of the following additional features a. to d:
a. The annular seal is mounted on the circular edge of the first metal disk.
b. The annular seal is mounted on the circular edge of the pole cap.
c. The annular seal is mounted on the circular edge of the pole cap and the circular edge of the first metal disk.
d. The circular edge of the first metal disk is folded over in a U-shape around the circular edge of the pole cap.

Feature a. is generally preferred if the diameter of the first metal disk is larger than the diameter of the pole cap. Feature b. is generally preferred if the diameter of the first metal disk is smaller than the diameter of the pole cap. Feature d. may be preferred if the diameter of the first metal disk is equal to the diameter of the pole cap.

Feature d. is preferred.

According to an aspect, the present disclosure provides an energy storage cell having the immediately following features a. to f:
a. The energy storage cell comprises an electrode-separator assembly with the sequence anode/separator/cathode,
b. the electrode-separator assembly is in the form of a cylindrical winding with a first terminal end face and a second terminal end face and a winding shell located therebetween,
c. the cell comprises an air- and liquid-tight housing comprising a metallic housing cup with a terminal circular opening and a lid assembly with a circular edge, that closes the circular opening,
d. the lid assembly is formed as described above,
e. the housing cup comprises, in axial sequence, a bottom, a central section and a closure section, wherein
   the central section is cylindrical and in the central section the winding shell of the electrode-separator assembly is in contact with the inside of the housing cup, and
   in the closure section, the annular seal of the lid assembly is in press contact with the edge of the pole cap and/or the edge of the first metal disk and the inside of the housing cup, and
f. the housing cup has in the closure section an opening edge defining the terminal circular opening, which is bent radially inwards over the edge of the pole cap and/or the first metal disc, which is or are enclosed by the seal, and which positively fixes the lid assembly including the seal in the circular opening of the housing cup.

The term “edge of the pole cap and/or the first metal disk” encompasses the embodiments described above, according to which the diameters of the pole cap and the metal disk are either different or the same. The component with the larger diameter is decisive with regard to the press contact, as the seal is in contact with it. The embodiment in which the circular edge of the first metal disk is folded around the edge of the pole cap in a U-shape is preferred.

In some preferred embodiments, the radially inwardly bent opening edge of the housing cup has a higher wall thickness than the housing cup in the central section.

This measure ensures that conductor rails can be welded onto the radially inwardly bent opening edge of the housing cup without accompanying problems with the seal. The increased thickness of the opening edge ensures that the heat generated during welding can be better distributed, so that local overheating and melting of the seal can be avoided.

The same effect can be achieved by welding a ring-shaped washer onto the inwardly bent opening edge of the housing cup. The washer provides an annulus-shaped flat surface that can serve as a support for a conductor rail. Preferably the washer has an outer diameter that does not exceed the outer diameter of the housing cup. For example, the outer diameter can be in the range of 1 cm to 10 cm, more preferably in the range of 1.5 cm to 7 cm. Of course, this depends on the absolute dimensions of the respective energy storage cell. The width of the annulus-shaped flat surface is preferably in the range of 2 mm to 3 cm, preferably in the range of 4 mm to 2 cm, in some preferred embodiments in the range of 2 mm to 5 mm. The thickness of the washer is preferably in the range of 0.1 mm to 5 mm, preferably in the range of 0.5 mm to 3 mm. Preferably, the ring disk has a circular hole in its center through which the pole cap is accessible from the outside or through which a preferably central elevation of the pole cap can protrude.

Preferably, the washer is plane on its upper side and its lower side. In preferred embodiments, this means that there is a maximum height difference of 0.2 mm between the highest and lowest points of the upper and lower sides, and further preferably a maximum height difference of 0.08 mm. In a further preferred embodiment, the annular disk forms an angle of 90° with the wall of the housing cup in the central section.

Preferably, the washer is welded onto the opening edge such that the outer edge of the annular disk is at a uniform distance from the opening edge defining the circular opening.

At this point, it should be emphasized that the washer can be used totally independent from the design of the seal of the lid assembly. Welding on the ring washer can be realized for any energy storage cell with features a. to c. as well as e. and f. of claim 5. Feature d. of claim 5 is optional.

The electrode-separator assembly is preferably in direct contact with the inside of the housing cup. It is preferably in direct contact with the inside of the housing cup. In some embodiments, however, it may be provided to electrically insulate the inside of the housing cup, for example by means of a film. In this case, the electrode-separator assembly is in contact with the inner wall via the film.

The bottom of the housing cup is preferably circular. The housing cup is preferably formed by deep drawing. However, it is also possible to form the cup by welding a bottom into a tubular half-part.

The energy storage cell is preferably a cylindrical cell. The electrode-separator assembly comprises the anode and the cathode, preferably in the form of ribbons. Furthermore, it preferably comprises a ribbon-shaped separator or two ribbon-shaped separators. The end faces of the cylindrical cell are preferably bounded by a circular edge.

The height of the cylindrical cell is preferably in the range of 50 mm to 150 mm. Its diameter is preferably in the range of 15 mm to 60 mm. Cylindrical round cells with these form factors are suitable for supplying power to electric drives in motor vehicles.

### Embodiment as a Lithium-Ion Cell

In a preferred embodiment, the energy storage cell is a lithium-ion cell.

Basically, all electrode materials known for secondary lithium-ion cells can be used for the electrodes of the energy storage cell.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity to absorb lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y +z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the aforementioned materials can also be used. The cathodic active materials are also preferably used in particulate form.

In addition, the electrodes of an energy storage cell preferably contain an electrode binder and/or an additive to improve the electrical conductivity. The active materials are preferably embedded in a matrix of the electrode binder, with neighboring particles in the matrix preferably being in direct contact with each other. Conductive agents have the function of increasing the electrical conductivity of the electrodes. Common electrode binders are based, for example, on polyvinylidene fluoride (PVDF), (Li-) polyacrylate, styrene-butadiene rubber or carboxymethyl cellulose or mixtures of different binders. Common conductive agents are carbon black, fine graphite, carbon fibers, carbon nanotubes and metal powder.

The energy storage cell preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato) borate (LiBOB).

Preferably, the nominal capacity of a lithium-ion-based energy storage cell is up to 15000 mAh. With the form factor of 21 mm×700 mm, a lithium-ion cell preferably has a nominal capacity in the range from 1500 mAh to 7000 mAh, preferably in the range from 3000 to 5500 mAh. With the form factor of 18 mm×650, a lithium-ion cell preferably has a nominal capacity in the range from 1000 mAh to 5000 mAh, preferably in the range from 2000 to 4000 mAh.

In the European Union, manufacturers' specifications regarding the nominal capacities of secondary batteries are strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Sodium-Ion-Based Cells

In further embodiments, the energy storage cell may also be a sodium-ion cell, a potassium-ion cell, a calcium-ion cell, a magnesium-ion cell or an aluminum-ion cell. Among these variants, energy storage cells with sodium-ion cell chemistry are preferred.

Preferably, the sodium ion-based energy storage cell comprises an electrolyte comprising at least one of the following solvents and at least one of the following conducting salts:

Organic carbonates, ethers, nitriles and mixtures thereof are suitable as solvents. Preferred examples are
Carbonates: Propylene carbonate (PC), ethylene carbonate-propylene carbonate (EC-PC), propylene carbonate-dimethyl carbonate-ethyl methyl carbonate (PC-DMC-EMC), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC), ethylene carbonate-dimethyl carbonate-diethyl carbonate (EC-DMC-DEC)
Ethers: tetrahydrofuran (THF), 2-methyltetrahydrofuran, dimethyl ether (OME), 1,4-dioxane (DX), 1,3-dioxolane (DOL), diethylene glycol dimethyl ether (DEGDME), tetraethyl glycol dimethyl ether (TEGDME)
Nitriles: Acetonitrile (ACN), adiponitrile (AON), y-butyrolactone (GBL)

Trimethyl phosphate (TMP) and tris (2,2,2-trifluoroethyl)phosphate (TFP) can also be used.

Preferred conductive salts are: NaPF₆, sodium difluoro (oxalato) borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaClO₄, NaB (C₂O₄)₂, NaP(C₆H₄O₂) 3; NaCF₃SO₃, sodium triflate (NaTf) and Et₄NBF₄.

In preferred embodiments, additives may be added to the electrolyte. Examples of preferred additives, in particular for stabilization, are the following:

Fluoroethylene carbonate (FEC), transdifluoroethylene carbonate (DFEC), ethylene sulfite(ES), vinylene carbonate (VC), bis(2,2,2-trifluoroethyl) ether (BTFE), sodium 2-trifluoromethyl-4,5-dicyanoimidazole (NaTDI), sodium bis(fluorosulfonyl)imide (NaFSI), aluminum chloride (AICI₃), ethylene sulfate (DTD), sodium difluorophosphate (NaPO₂F₂), sodium difluoro (oxalato) borate (NaODFB), sodium difluorobisoxalatophosphate (NaDFOP) and tris (trimethylsilyl) borate (TMSB).

The negative electrode material of an energy storage cell based on sodium ions is preferably at least one of the following materials:
carbon, especially hard carbon (pure or with nitrogen and/or phosphorus doping) or soft carbon or graphene-based materials (with N-doping); carbon nanotubes, graphite
Phosphorus or sulphur (conversion anode)
Polyanions: Na₂ Ti₃O₇, Na₃Ti₂ (PO₄)₃, TiP₂O₇, TiNb₂O₇, Na-Ti-(PO₄)₃, Na-V-(PO₄)₃
Prussian blue: low-Na variant (for systems with aqueous electrolyte)
Transition metal oxides: V₂O₅, MnO₂, TiO₂, Nb₂O₅, Fe₂O₃, Na₂Ti₃O₇, Na₄CrTi₅O₄, Na₄Ti₅O₁₂
MXenes with M=Ti, V, Cr, Mo or Nb and A=AI, Si, and Ga and X=C and/or N, e.g. Ti₃C₂
Organic: e.g. Na terephthalates (Na₂C₈H₂O₄)

Alternatively, a sodium metal anode can also be used on the anode side.

The positive electrode material of an energy storage cell based on sodium ions may comprise or is, for example, at least one of the following materials:
Polyanions: NaFePO₄ (Triphylit-Type), Na₂Fe(P₂O₇), Na₄Fe₃(PO₄)₂(P₂O₇), Na₂FePO₄F, Na/Na₂[Fe_{1/2}Mn_{1/2}]PO₄F, Na₃ V₂(PO₄)₂F₃, Na₃V₂(PO₄)₃, Na₄(CoMnNi)₃(PO₄)₂P₂O₇, NaCoPO₄, Na₂CoPO₄F
Silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

In addition, the electrodes of an sodium ion cell preferably may contain an electrode binder and/or an additive to improve the electrical conductivity. The active materials are preferably embedded in a matrix of the electrode binder, whereby the active materials are preferably used in particulate form and neighboring particles in the matrix are preferably in direct contact with each other. Conductive agents have the function of increasing the electrical conductivity of the electrodes. Common electrode binders are based on polyvinylidene fluoride (PVDF), (Na-) polyacrylate, styrene-butadiene rubber, (Na-) alginate or carboxymethyl cellulose, for example, or mixtures of different binders. Common conductive agents are carbon black, fine graphite, carbon fibers, carbon nanotubes and metal powder.

In a preferred embodiment of an energy storage cell based on sodium-ion technology, both the anode and the cathode current collector consist of aluminum or an aluminum alloy. The housing and the contact sheet metal members as well as any other current conductors within the housing can also consist of aluminum or the aluminum alloy.

### Preferred Wall Thicknesses of the Housing Cup

Preferably, the energy storage cell is characterized by at least one of the features a. to c. immediately below:
a. The radially inwardly bent opening edge of the housing cup is thicker by a factor in the range of 1.5 to 2 than the housing cup in the central section.
b. The housing cup has a wall thickness in the range from 0.1 mm to 0.4 mm in the central section, preferably in the range from 0.25 mm to 0.3 mm.
c. The radially inwardly bent opening edge of the housing cup has a wall thickness in the range from 0.15 mm to 0.8 mm, preferably in the range from 0.375 mm to 0.6 mm.

It is preferred that the immediately preceding features a. and b. as well as a. and c. are realized in combination. It is preferred that all three immediately preceding features a. to c. are realized in combination.

The bottom of the housing cup preferably has a thickness in the range of 0.2 mm to 2 mm.

### Preferred Variants Regarding the Higher Wall Thickness of the Opening Edge

In order to realize the higher wall thickness of the opening edge, a starting material can already be used in the production of the housing cup, which is thickened in areas intended to form the opening edge. However, it is preferable to reinforce the opening edge by bending or folding the wall of the housing cup in order to achieve the greater wall thickness.

Accordingly, preferred embodiments are characterized by at least one of the features a. to c. immediately below:
a. The radially inwardly bent opening edge of the housing cup is double-layered.
b. The double-layered opening edge is formed by folding or bending the opening edge.
c. The double-layered opening edge has a U-shaped cross-section, in particular as a result of the folding or bending according to feature b. immediately above.

It is preferred that the immediately preceding features a. and b., preferably all three immediately preceding features a. to c., are realized in combination.

The folding or bending to form the double-layer opening edge can be done outwards or inwards. This results in different variants of the double-layered opening edge.

Preferably, the energy storage cell is characterized by at least one of the features a. to c. immediately below:
a. The double-layered opening edge has a first layer which is in direct contact with the seal surrounding the edge of the lid assembly, and a second layer parallel to the first on a side of the first layer facing away from the seal.
b. The first layer is bounded by a cut edge that points radially outwards.
c. The second layer is bounded by a cut edge that points radially outwards.

It is preferred that the immediately preceding features a. and b. or the immediately preceding features a. and c. are realized in combination.

In the variant with features a. and b., it is advantageous that the outward-facing cut edge is protected from corrosion, as it is shielded from the environment of the cell by the second layer and the outer wall of the cup.

The housing cup preferably consists of aluminum, an aluminum alloy or a sheet steel, for example a nickel-plated sheet steel.

Suitable aluminum alloys for the housing cup are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

### Contact Surface for Conductors

Preferably, the energy storage cell is characterized by at least one of the features a. to d. immediately below:
a. The opening edge bent radially inwards, in particular the double-layered opening edge, comprises a first, inner side, which is in direct contact with the seal, and a second side facing away from the seal.
b. The second side has the shape of a annulus-shaped flat surface or comprises an annulus-shaped flat surface.
c. The annulus-shaped flat surface forms a ring with an annulus width in the range from 1 mm to 5 mm, preferably in the range from 1 mm to 3 mm, preferably in the range from 1.2 mm to 1.3 mm.
d. The annulus-shaped flat surface forms an angle of 90° with the wall of the housing cup in the central section.

It is preferred that the immediately preceding features a. and b. and c. or the immediately preceding features a. and b. and d. or the immediately preceding features a. to d. are realized in combination.

In these preferred embodiments, welding on a metal electrical conductor, for example a metal arrester bar or a rail, can be facilitated by optimizing size and flatness of the radially inwardly bent opening edge. The annulus-shaped flat surface is therefore preferably used for welding on metal electrical conductors.

With regard to the electrical conductor to be welded on, it is advantageous if the annulus-shaped flat surface is characterized by a high degree of flatness. The energy storage cell is characterized by feature a. immediately below:
a. There is a maximum height difference of 0.08 mm between the highest and lowest points of the annulus-shaped flat surface.

Vice versa, the annulus-shaped flat surface located on the second side of the double-layered opening edge is in preferred embodiments defined by the fact that there is a maximum height difference of 0.08 mm between the highest and lowest points of the annulus-shaped flat surface. Or in other words: This degree of flatness preferably defines the boundaries of the annulus-shaped flat surface.

Preferably, in the case of cells with a diameter ≤26 mm wide, the circular ring-shaped flat surface forms an annulus with an annulus width in the range of 0.5 mm-1.5 mm, preferably from 1 mm to 1.5 mm.

Preferably, in the case of cells with a diameter >26 mm wide, the circular ring-shaped flat surface forms an annulus with an annulus width in the range of 0.8 mm-3.5 mm, preferably from 1 mm to 2.5 mm.

In preferred embodiments, the radially inwardly bent opening edge of the housing cup has the higher wall thickness everywhere in the area of the annulus-shaped flat surface. As the annulus-shaped flat surface is used to weld on the diverter, this ensures good shielding of the seal in this sensitive area.

### Preferred Embodiments of the Housing

Preferably, the energy storage cell is characterized by at least one of the features a. to c. immediately below:
a. The central section and the closure section are separated by an indentation that circumferentially surrounds the outside of the housing cup.
b. The housing cup has an identical maximum outer diameter in the central section and in the closure section.
c. In the region of the indentation, the outer diameter of the housing cup is reduced by 4 to 12 times the wall thickness of the housing cup in this region.

It is preferred that at least the immediately preceding features a. and b. are realized in combination. It is preferred that all three immediately preceding features a. to c. are realized in combination.

Preferably, the annular seal is compressed in the closure section. It is preferably pressed radially against the circular edge of the pole cap and/or the first metal disk.

### Electrical Contacting of the Electrodes

As stated above, the present disclosure provides energy storage cells that are characterized by a high energy density. This is possible if the electrode winding is efficiently connected to the housing, for example as described in WO 2017/215900 A1.

Preferably, the energy storage cell is characterized by at least one of the features a. to e. immediately below:
a. The anode of the electrode-separator assembly comprises an anode current collector having a first longitudinal edge and a second longitudinal edge parallel thereto.
b. The anode current collector comprises a main region loaded with a layer of negative electrode material and a free edge strip extending along its first longitudinal edge which is not loaded with the negative electrode material.
c. The cathode of the electrode-separator assembly comprises a cathode current collector having a first longitudinal edge and a second longitudinal edge parallel thereto.
d. The cathode current collector comprises a main region loaded with a layer of positive electrode material and a free edge strip extending along its first longitudinal edge which is not loaded with the electrode material.
e. The anode and the cathode are arranged within the electrode-separator assembly in such a way that the first longitudinal edge of the anode current collector protrudes from the first terminal end face and the first longitudinal edge of the cathode current collector protrudes from the second terminal end face of the electrode-separator assembly.

It is preferred that all five immediately preceding features a. to e. are realized in combination.

In a further development of this preferred embodiment, it is preferred that the energy storage cell is characterized by at least one of the features a. to d. immediately below:
a. The energy storage cell comprises a contact sheet metal member which sits on the first longitudinal edge of the anode current collector and covers the first end face or which sits on the first longitudinal edge of the cathode current collector and covers the second end face and is connected thereto by a welding connection.
b. The contact sheet metal member is connected to the first longitudinal edge of the anode current collector or the first longitudinal edge of the cathode current collector by a welding connection.
c. The contact sheet metal member is connected to the bottom of the housing cup, in particular by a welding connection.
d. The contact sheet metal member plate is electrically connected to the lid assembly.

It is preferred that at least the immediately preceding features a. to c. or features a. and b. and d. are realized in combination.

In some preferred embodiments, the energy storage cell comprises a contact sheet metal member which sits on the first longitudinal edge of the anode current collector and is connected thereto by a welding connection, and a further contact plate which sits on the first longitudinal edge of the cathode current collector and is connected thereto by a welding connection.

In a possible further development, it is preferred that the energy storage cell is characterized by the immediately following feature a:
a. The first longitudinal edge of the anode current collector or the first longitudinal edge of the cathode current collector sits directly on the bottom of the housing cup and is connected to it by a welding connection.

In this embodiment, one of the current collectors is directly connected to the housing or the housing cup. In a preferred variant of this embodiment, a contact sheet metal member rests or sits on the longitudinal edge of the other current collector. This is then electrically connected to the lid assembly.

### Preferred Embodiments of the Contact Sheet Metal Member

In a preferred embodiment, a contact sheet metal member that is electrically connected to the anode current collector is characterized by at least one of the immediately following features a. and b.:
a. The contact sheet metal member consists of nickel or copper or titanium or a nickel or copper or titanium alloy or stainless steel, for example of type 1.4303 or 1.4404 or of type SUS304, or of nickel-plated copper.
b. The contact sheet metal member consists of the same material as the anode current collector.

In a further preferred embodiment, a contact sheet metal member that is electrically connected to the cathode current collector is characterized by at least one of the features a. and b. immediately below:
a. The contact sheet metal member consists of aluminum or an aluminum alloy.
b. The contact sheet metal member consists of the same material as the anode current collector.

Preferably, a contact sheet metal member that is electrically connected to the anode current collector and/or contact sheet metal member that is electrically connected to the cathode current collector is characterized by at least one of the immediately following features a. to g.:
a. The contact sheet metal member has a preferably uniform thickness in the range from 50 μm to 600 μm, preferably in the range from 150 μm to 350 μm.
b. The contact sheet metal member has two opposite flat sides and extends essentially in only one dimension.
c. The contact sheet metal member is a disk or a plate, for example a circular plate or a polygonal plate.
d. The contact sheet metal member is dimensioned such that it covers at least 60%, preferably at least 70%, preferably at least 80% of the first terminal end face or of the second terminal end face.
e. The contact sheet metal member comprises at least one aperture, in particular at least one hole and or at least one slot.
f. The contact sheet metal member has at least one bead, which appears on one flat side of the contact sheet metal member as an elongated depression and on the opposite flat side as an elongated elevation. It is preferred that such a contact sheet metal member rests or sits with the flat side, which carries the elongated elevation, on the first longitudinal edge of the respective current collector.
g. The contact sheet metal member is welded to the first longitudinal edge of the respective current collector in the area of the bead or one of the beads, in particular via one or more weld seams or weld spots in the bead.

It is preferred that the immediately preceding features a. and b. and d. are realized in combination with each other. In a preferred embodiment, features a. and b. and d. are realized in combination with one of features c. or e. or features f. and g. Preferably, all features a. to g. are realized in combination.

Covering as much of the end face as possible is important for the thermal management of the energy storage cell. The larger the cover, the easier it is to contact large parts of the first longitudinal edge of the respective current collector or even to make contact over its entire length. Heat formed in the electrode-separator assembly can thus be dissipated well via the contact sheet metal member.

In some embodiments, it has proven advantageous to subject the longitudinal edge of the current collector to a pretreatment before the contact sheet metal member is placed on top of it. In particular, at least one depression can be folded into the longitudinal edge, which corresponds to the at least one bead or the elongated elevation on the flat side of the contact plate facing the first terminal end face.

The longitudinal edge of the current collector may also have been subjected to directional forming by pre-treatment. For example, it can be bent in a defined direction.

The at least one aperture in the contact sheet metal member can, for example, be useful for impregnating the electrode-separator assembly with an electrolyte.

### Preferred Embodiments of Current Collectors and Separators

The anode current collector, the cathode current collector and the separator or the separators of the cell preferably have the following dimensions:
A length in a range from 0.5 m to 25 m
A width in a range from 40 mm to 145 mm

In the electrode-separator assembly, the ribbon-shaped anode, the ribbon-shaped cathode and the ribbon-shaped separator(s) are preferably wound in a spiral. To produce the ribbon-shaped electrode-separator assembly, the ribbon-shaped electrodes and the ribbon-shaped separator(s) can be fed to a winding device, where they are preferably spirally wound around a winding axis. Bonding of the electrodes and separators or contacting at elevated temperatures is usually not necessary. In some embodiments, the electrodes and the separator or separators are wound onto a for example cylindrical or hollow-cylindrical winding core, which is seated on a winding mandrel and remains in the winding after winding.

The shell of the winding (winding shell) can be formed by a plastic film or an adhesive tape, for example. It is also possible for the winding shell to be formed by one or more separator windings.

The current collectors of the energy storage cell have the function of electrically contacting electrochemically active components contained in the respective electrode material over as large an area as possible. Preferably, the current collectors consist of a metal or are at least metallized on the surface.

In the case of a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are suitable as nickel alloys. Alloys of the type NiFe, NiCu, CuNi, NiCr and NiCrFe are suitable as nickel alloys. Stainless steel can also be considered, for example type 1.4303 or 1.4404 or type SUS304.

In the case of a lithium-ion cell, aluminum or other electrically conductive materials, including aluminum alloys, are suitable as a metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a ribbon-shaped metal foil with a thickness in the range from 4 μm to 30 μm.

In addition to foils, however, other strip-shaped substrates such as metallic or metallized nonwovens or open-pored metallic foams or expanded metals can also be used as current collectors.

The current collectors are preferably loaded with the respective electrode material on both sides.

It is preferred that the longitudinal edges of the separator or separators form the end faces of the electrode-separator assembly.

### Preferred Embodiments of the Lid Assembly

The cell is preferably characterized by the fact that a CID function is integrated into the lid assembly, which ensures that if the pressure in the cell is too high, the pressure can escape from the housing and at the same time the electrical contact between the lid assembly and the electrode-separator assembly can break off.

Preferably, the energy storage cell is accordingly characterized by at least one of the features a. and b. immediately below:
a. The first metal disk of the lid assembly comprises a metallic membrane that bulges outwards or bursts in the event of a certain excess of pressure inside the housing.
b. The first metal disk of the lid assembly with the membrane is in electrical contact with an electrical conductor that is electrically connected to the anode current collector or to the cathode current collector.

It is preferred that the immediately preceding features a. and b. are realized in combination.

### Possible Designs of the Seal

In order to additionally limit the effects of the welding process on the seal, it is preferred to use particularly temperature-resistant plastics as the sealing material.

In a further development of this preferred embodiment, it is correspondingly preferred that the energy storage cell is characterized by at least one of the immediately following features a. and b:
a. The seal consists of a plastic material that has a melting point >200° C., preferably >300° C., preferably a melting point >300° C. and <350° C.
b. The plastic material is a polyether ether ketone (PEEK), a polyimide (PI), a polyphenylene sulphide (PPS) or a polytetrafluoroethylene (PTFE) or a polyamide (PA) or a polyphtalamide (PPA) or a polybutylene terephthalate (PBT) or a perfluoroalkoxy polymer (PFA) or an ethylene propylene diene rubber (EPDM).

It is preferred that the immediately preceding features a. and b. are realized in combination.

### Assembly of Energy Storage Cells

According to an aspect, the present disclosure provides an assembly of energy storage cells characterized by the following features:
a. The assembly comprises at least two of the energy storage cells described above and
b. the assembly comprises at least one electrical conductor made of a metal, which is connected by welding to the radially inwardly bent opening edges of the housing cups of the at least two energy storage cells.

The at least one conductor can, for example, be a conductor, in particular a rail, made of aluminum or an aluminum alloy.

Suitable aluminum alloys for the conductor include Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

In some preferred embodiments, the conductor is a metal sheet strip, for example made of aluminum, with a thickness in the range of 2 to 5 mm, preferably with a thickness of 3.5 mm.

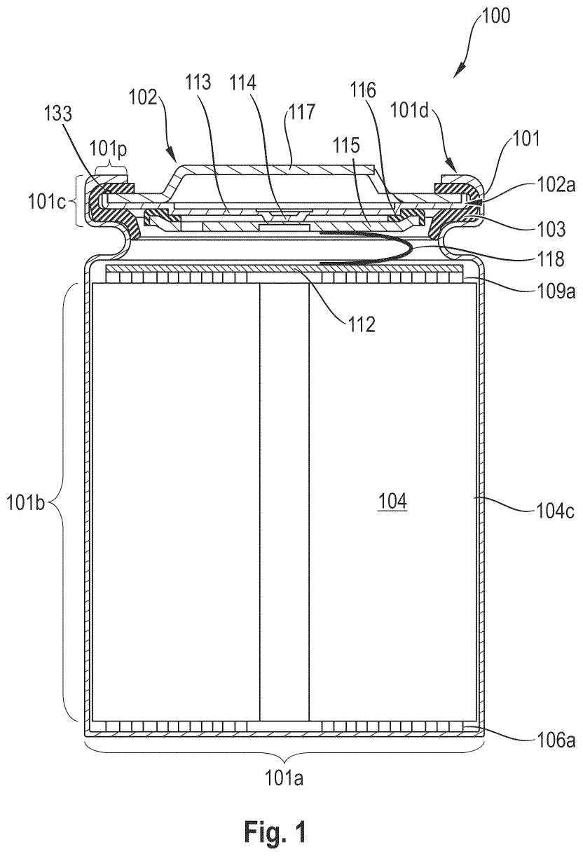

FIG. 1 shows an energy storage cell 100 with an airtight and liquid-tight housing comprising a metallic housing cup 101 with a terminal circular opening and a lid assembly 102 with a circular edge 102a which closes the circular opening. The cell further comprises an annular seal 103 made of an electrically insulating material, which encloses the circular edge 102a of the lid assembly 102 and electrically insulates the housing cup 101 and the lid assembly 102 from each other. The housing cup 101 comprises in axial sequence a bottom 101a, a central section 101b and a closure section 101c, wherein the central section 101b is cylindrical and in the central section 101b the winding shell 104c of the electrode-separator assembly 104, which is formed as a winding, is in contact with the inside of the housing cup 101, and in the closure section 101c the annular seal 103 is in press contact with the lid assembly 102 and the inside of the housing cup 101. In the closure section 101c, the housing cup 101 has an opening edge 101d defining the circular opening, which is bent radially inwards over the edge 102a of the lid assembly 102 enclosed by the seal 103 and which positively fixes the lid assembly 102 including the seal 103 in the circular opening of the housing cup 101. The radially inwardly bent opening edge 101d of the housing cup 101 has a greater wall thickness than the housing cup 101 in the central section 101b. As a result, it is possible to carry out welding processes on the opening edge 101d without damaging the seal 103.

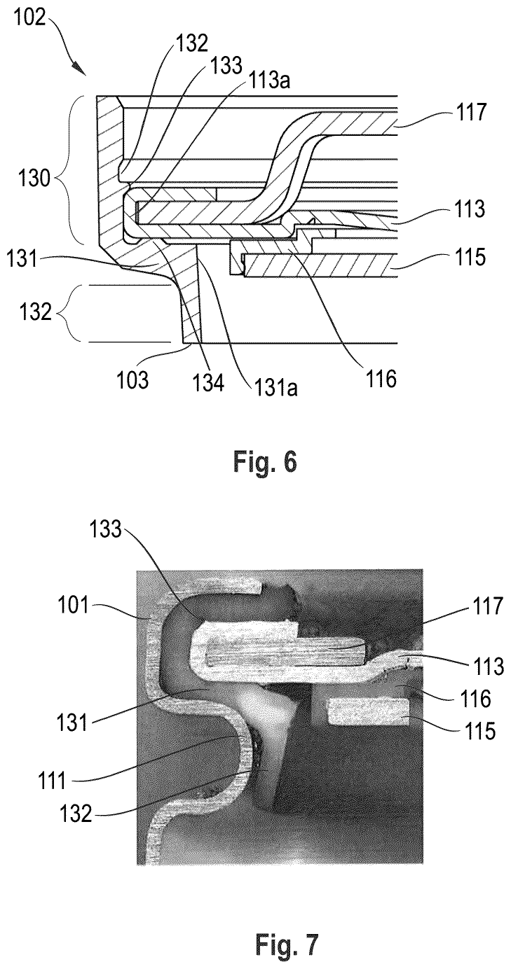

The seal has a nose 133 provided with an undercut. The nose is compressed together with the seal and thus deformed and pushed into a recess formed by the undercut (see FIG. 6).

The cell 100 also comprises an electrode-separator assembly 104 in the form of a cylindrical winding with the sequence anode/separator/cathode, which, however, is only shown schematically here. Only the longitudinal edge 106a of the anode current collector 106, which protrudes from the end face 104a of the electrode-separator assembly 104, and the longitudinal edge 109a of the anode current collector 109, which protrudes from the end face 104b of the electrode-separator assembly 104, can be seen. The longitudinal edge 106a is welded directly to the housing bottom 101a, preferably over its entire length. The longitudinal edge 109a is welded directly to the plate-shaped contact sheet metal member 112, preferably over its entire length. The plate-shaped contact sheet metal member 112 is in turn connected to the lid assembly 102 via the electrical conductor 118, which will be described in more detail below.

The cell 100 preferably has a height in the range from 60 mm to 10 mm, its diameter is preferably in the range from 20 mm to 50 mm. The housing cup 101 preferably has a wall thickness in the range from 0.1 mm to 0.3 mm in the central section 101b. The radially inwardly bent opening edge 101d of the housing cup 101 is preferably thicker by a factor in the range of 1.5 to 2 than the housing cup 101 in the central section 101b. It comprises a first, inner side, which is in direct contact with the seal 103, and a second side facing away from the seal 103. The second side comprises the annulus-shaped flat surface 101p. This forms an annulus with a preferred annulus width in the range from 0.8 mm to 3 mm and forms an angle of 90° with the wall of the housing cup 101 in the central section 101b. There is a maximum height difference of 0.08 mm between the highest and the lowest point of the annulus-shaped flat surface.

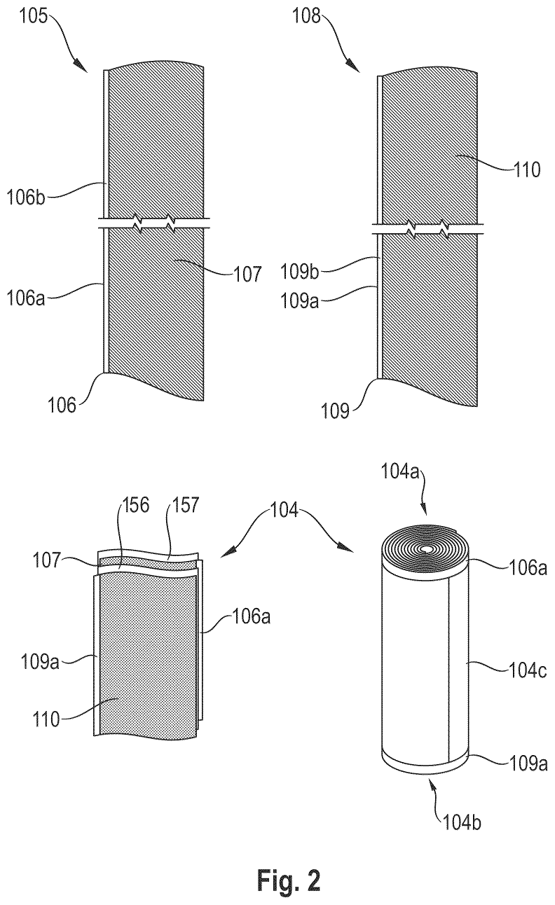

The structure of the electrode-separator assembly 104 is illustrated with reference to FIG. 2. The assembly 104 comprises the ribbon-shaped anode 105 with the ribbon-shaped anode current collector 106, which has a first longitudinal edge 106a and a second longitudinal edge parallel thereto. The anode current collector 106 is a foil made of copper or nickel. This comprises a strip-shaped main region, which is loaded with a layer of negative electrode material 107, and a free edge strip 106b, which extends along its first longitudinal edge 106a and which is not loaded with the electrode material 107. Further, the assembly 104 comprises the ribbon-shaped cathode 108 with the ribbon-shaped cathode current collector 109 having a first longitudinal edge 109a and a second longitudinal edge parallel thereto. The cathode current collector 109 is an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown individually in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 156 and 157 are also shown there, which separate the electrodes 105 and 108 from each other in the winding.

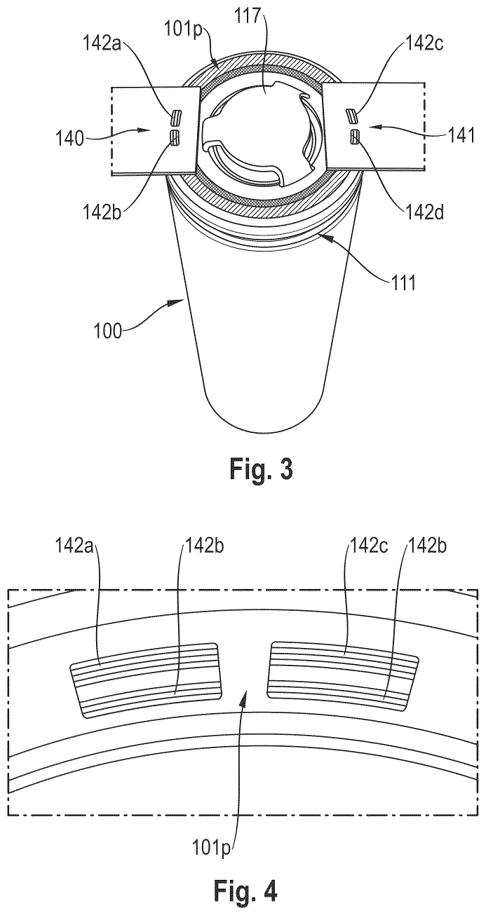

In the illustration at the bottom right, the electrode-separator assembly 104 is shown in wound form, as it can be used in an energy storage cell for example according to one of FIGS. 1 and 3. The edges 106a and 109a protruding from the end faces 104a and 104b are clearly visible. The winding shell 104c is preferably formed by a plastic film.

FIG. 3 shows an energy storage cell 100 having a design according to FIG. 1 with two welded-on electrical conductors 140 and 141. The electrical conductors 140 and 141 each consist of a metal and are connected to the radially inwardly bent opening edge of the housing cup of the energy storage cell 100 by welding. Both electrical conductors 140 and 141 are welded onto the annulus-shaped flat surface 101p of the opening edge. The energy storage cell 100 can be connected to neighboring cells of the same type via the electrical conductors 140 and 141.

Cell analyses have shown that the seal located under the flat surface 101p was not damaged by the welding process.

FIG. 4 shows the underside of an inwardly bent opening edge of a housing cup onto the upper side of which an electrical conductor has been welded. Two weld seams (142a and 142b as well as 142c and 142d) are arranged parallel to each other. The weld seams are each formed from several individual weld seams running parallel to each other. Such weld seams can be formed efficiently using a laser.

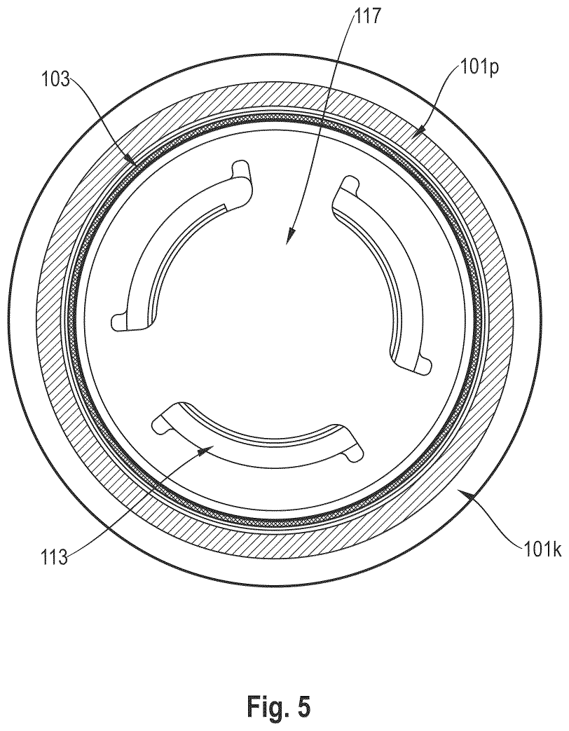

FIG. 5 shows a top view of a lid component of an energy storage cell as shown in FIG. 1. The annulus-shaped flat surface 101p as well as an edge of the seal 103 and the pole cap 117 can be seen. In the area of the annulus-shaped flat surface 101p, there is a maximum height difference of 0.08 mm between the highest and the lowest point of the annulus-shaped flat surface. The surface 101p extends to the inner edge of the inwardly bent opening edge, under which the seal 103 protrudes. Towards the outside, the flat surface 101p adjoins the curved region 101k.

The lid assembly 102 shown in FIG. 6 comprises the pole cap 117, the first metal disc 113, the second metal disc 115, the annular seal 103 and the annular insulator 116. The first metal disc 113 is arranged between the pole cap 117 and the second metal disc 115. The annular insulator 116 electrically insulates the first metal disk 113 from the second metal disk 115, whereas the first metal disk 113 is in direct contact with the pole cap 117.

The annular seal 103 is mounted on the circular edge of the first metal disk 113, which is folded over in a U-shape around the edge of the pole cap 117.

The seal 103 comprises an outer annular segment 130 which opens at its lower end into an inwardly pointing collar 131 which narrows the outer annular segment 130 at this end. The collar 131 has an inner edge 131a, which continues into the inner annular segment 132, which has a smaller diameter than the outer annular segment 130. The outer annular segment 130 has an inwardly pointing circumferential nose 133 provided with an undercut 132.

The U-shaped edge of the first metal disk 113, which is folded around the edge of the pole cap 117, sits on the collar 131 and is held in place by the nose 133.

The sectional photo according to FIG. 7 shows the closure section of a lid assembly according to FIG. 6 in an assembled state. The edge of the housing cup 101 is bent inwards and fixes the lid assembly with the pole cap 117, the first metal disc 113 and the second metal disc 115 as well as the annular insulator 116. The seal 103 is compressed in the closure section. It is preferably pressed from below and from above as well as radially against the circular, U-shaped edge of the first metal disk 113. The collar 131 and the inner annular segment 132 are also clearly visible. The annular segment 132 is pulled downwards and shields the indentation 111 towards the inside. The recess formed by the undercut 132 can also be seen here, which is partially filled by the nose 133, which is deformed as a result of the compression and bending of the seal, which is clearly visible here.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B. or the entire list of elements A, B and C.

1. An annular seal for a lid assembly of an energy storage cell, the annular seal comprising:
an outer annular segment with two ends, wherein the outer annular segment continues, at a first end of the two ends, into an inward-facing collar that narrows the outer annular segment at the first end, an inner edge of the inward-facing collar continuing into an inner annular segment,
wherein the outer annular segment has an inwardly pointing circumferential nose provided with an undercut.

2. The annular seal according to claim 1, wherein at least one of:
the outer annular segment is hollow cylindrical,
the inner annular segment is hollow cylindrical or conically tapering,
the undercut is designed as an annular, groove-like recess,
the nose is formed as an annular elevation on the inside of the outer annular segment,
the nose provided with the undercut divides the outer annular segment into a central part segment and a terminal part segment, and/or
the collar has an annular elevation on its inner side.

3. A lid assembly for an energy storage cell, the lid assembly comprising:
a pole cap with a circular edge;
a first metal disk with a circular edge;
a second metal disk with a circular edge;
the annular seal according to claim 1; and
an annular insulator,
wherein the first metal disk is arranged between the pole cap and the second metal disk,
wherein the annular insulator electrically insulates the first metal disk and the second metal disk from each other,
wherein the first metal disk is in direct contact with the pole cap,
wherein the annular seal is mounted on the circular edge of the pole cap and/or on the circular edge of the first metal disk,
wherein the circular edge of the pole cap and/or the circular edge of the first metal disk rests on the collar, and is held in place by the nose.

4. The lid assembly according to claim 3, wherein at least one of:
the annular seal is mounted on the circular edge of the first metal disk,
the annular seal is mounted on the circular edge of the pole cap,
the annular seal is mounted on the circular edge of the pole cap and the circular edge of the first metal disk,
the circular edge of the first metal disk is folded over in a U-shape around the circular edge of the pole cap.

5. An energy storage cell, comprising:
an electrode-separator assembly in the form of a cylindrical winding with a first terminal end face, a second terminal end face, and a winding shell located therebetween, the electrode-separator assembly including an anode, a separator, and a cathode with a sequence anode/separator/cathode;
an air- and liquid-tight sealed housing comprising:
a metallic housing cup with a terminal circular opening, the metallic housing cup comprising, in axial sequence, a bottom, a central section, and a closure section, and
a lid assembly according to claim 3,
wherein the central section is cylindrical,
wherein the winding shell of the electrode-separator assembly is in contact with the inside of the housing cup in the central section,
wherein, in the closure section, the annular seal of the lid assembly is in press contact with the edge of the pole cap and/or the edge of the first metal disk and the inside of the housing cup, and
wherein the housing cup includes, in the closure section, an opening edge defining the terminal circular opening, which is bent radially inwards over the edge of the pole cap and/or the first metal disc, which is or are enclosed by the seal, and which positively fixes the lid assembly including the seal in the circular opening of the housing cup.

6. The energy storage cell according to claim 5, wherein the radially inwardly bent opening edge of the housing cup has a higher wall thickness than the housing cup in the central section.

7. The energy storage cell according to claim 5, wherein at least one of:
the central section and the closure section are separated by an indentation that circumferentially surrounds an outside of the housing cup,
the housing cup has an identical maximum outer diameter in the central section and the closure section, and/or
in the area of the indentation, the outer diameter of the housing cup is reduced by 4 to 12 times the wall thickness of the housing cup in the area of the indentation.

8. The energy storage cell according to claim 5, wherein at least one of:
the anode of the electrode-separator assembly comprises an anode current collector having a first longitudinal edge and a second longitudinal edge parallel thereto,
the anode current collector comprises a main region loaded with a layer of negative electrode material and a free edge strip extending along the first longitudinal edge of the anode current collector that is not loaded with the negative electrode material,
the cathode of the electrode-separator assembly comprises a cathode current collector having a first longitudinal edge and a second longitudinal edge parallel thereto,
the cathode current collector comprises a main region loaded with a layer of positive electrode material and a free edge strip extending along the first longitudinal edge of the cathode current collector that is not loaded with the electrode material, and/or
the anode and the cathode are arranged within the electrode-separator assembly in such a way that the first longitudinal edge of the anode current collector protrudes from the first terminal end face and the first longitudinal edge of the cathode current collector protrudes from the second terminal end face of the electrode-separator assembly.

9. The energy storage cell according to claim 8, wherein at least one of:
the energy storage cell further comprises a contact sheet metal member that sits on the first longitudinal edge of the anode current collector and covers the first terminal end face or sits on the first longitudinal edge of the cathode current collector and covers the second terminal end face and is connected thereto by a welding connection,
the contact sheet metal member is connected to the first longitudinal edge of the anode current collector or the first longitudinal edge of the cathode current collector by a welding connection,
the contact sheet metal member is connected to the bottom of the housing cup, and/or
the contact sheet metal member is electrically connected to the lid assembly.

10. The energy storage cell according to claim 8, wherein the first longitudinal edge of the anode current collector or the first longitudinal edge of the cathode current collector sits directly on the bottom of the housing cup and is connected thereto by a welding connection.

11. The energy storage cell according to claim 5, wherein at least one of:
the disk of the lid assembly comprises a metallic membrane configured to bulge outwards or burst in an event of a certain excess pressure within the housing, and/or
the disk with the membrane is in electrical contact with an electrical conductor that is electrically connected to the anode current collector or to the cathode current collector.

12. The annular seal according to claim 1, wherein at least one of:
the annular seal comprises a plastic material that has a melting point >200° C.,
the plastic material is a polyether ether ketone, a polyimide, a polyphenylene sulphide or a polytetrafluoroethylene.

13. An assembly of energy storage cells, the assembly comprising:
at least two energy storage cells according to claim 5; and
an electrical conductor made of a metal that is connected by a welding connection to the radially inwardly bent opening edges of the housing cups of the at least two energy storage cells.
